(19) United States
(12) Patent Application Publication
(10) Pub. No.: US 2012/0159923 A1
(43) Pub. Date: Jun. 28, 2012

(54) SYSTEM AND METHOD FOR USING GAS TURBINE INTERCOOLER HEAT IN A BOTTOMING STEAM CYCLE

(75) Inventors: Sebastian Walter Freund, Unterfohring (DE); Richard Bodek, Schenectady, NY (US); Kenneth Charles Bodek, San Diego, CA (US); Thomas Johannes Frey, Regensburg (DE); Pierre Sebastien Huck, Munich (DE)

(73) Assignee: GENERAL ELECTRIC COMPANY, Schenectady, NY (US)

(21) Appl. No.: 12/977,169

(22) Filed: Dec. 23, 2010

(51) Int. Cl. F02C 6/04; F02G 5/02

(52) U.S. Cl. 60/39.182

(57) ABSTRACT

A steam cycle power plant includes a gas turbine, a gas turbine intercooler, a steam turbine, and a heat recovery steam generator (HRSG). The gas turbine intercooler recovers unused heat generated via the gas turbine and transfers substantially all of the recovered heat for generating extra steam for driving the steam turbine.

### BACKGROUND

This invention relates generally to gas turbine engines, and more particularly, to a system and method for extracting and using heat from a gas turbine's intercooler in a steam cycle.

Gas turbine engines generally include, in serial flow arrangement, a high-pressure compressor for compressing air flowing through the engine, a combustor in which fuel is mixed with the compressed air and ignited to form a high temperature gas stream, and a high-pressure turbine. The high-pressure compressor, combustor and high-pressure turbine are sometime collectively referred to as the core engine. At least some known gas turbine engines also include a low-pressure compressor, or booster, for supplying compressed air to the high pressure compressor.

Gas turbine engines are used in many applications, including aircraft, power generation, and marine applications. The desired engine operating characteristics vary, of course, from application to application. More particularly, within some applications, a gas turbine engine may include a single annular combustor, including a water injection system that facilitates reducing nitrogen oxide (NOx) emissions. Alternatively, within other known application, the gas turbine engine may include a dry low emission (DLE) combustor.

Gas turbines alone have a limited efficiency and a significant amount of useful energy is wasted as hot exhaust gas is discharged to the ambient. To improve the efficiency of a gas turbine power plant and use this heat for further power generation, many gas turbines are equipped with a heat recovery steam generator and a steam cycle. This is known as a combined cycle.

Inter-cooled gas turbine engines may include a combustor that may be a single annular combustor, a can-annular combustor, or a DLE combustor. While using an intercooler facilitates increasing the efficiency of the engine, the heat rejected by the intercooler is not utilized by the gas turbine engine, and the intercooler heat from an intercooled gas turbine or compressor is usually wasted. In some applications, a cooling tower discharges intercooler heat to the ambient at a low temperature level.

There is a need for a system and method for extracting and using heat from a gas turbine's intercooler in a steam cycle.

### BRIEF DESCRIPTION

According to one embodiment, a combined gas and steam turbine power plant comprises:

a gas turbine;

a gas turbine intercooler;

a steam turbine; and

a heat recovery steam generator (HRSG) configured to generate steam for driving the steam turbine in response to heated fluid received from the gas turbine intercooler.

According to another embodiment, a combined gas and steam turbine power plant comprises:

a gas turbine;

a gas turbine intercooler;

a steam turbine; and

a heat recovery steam generator (HRSG) connected downstream from a low-pressure gas turbine compressor and upstream from a high-pressure gas turbine compressor in a steam cycle, wherein the HRSG is configured to generate steam for driving the steam turbine in response to a heat transfer medium received via the gas turbine intercooler.

According to yet another embodiment, combined gas and steam turbine power plant comprises:

a gas turbine;

a gas turbine intercooler;

a steam turbine; and

a heat recovery steam generator (HRSG),

wherein the gas turbine intercooler is configured to recover the intercooling heat and use substantially all of the recovered heat to produce hot water and steam for driving the steam turbine.

### DRAWINGS

These and other features, aspects, and advantages of the present invention will become better understood when the following detailed description is read with reference to the accompanying drawing, wherein:

FIG. 1 is a block diagram of a gas turbine engine including an intercooler system; and

FIG. 2 illustrates a combined cycle power plant according to one embodiment.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

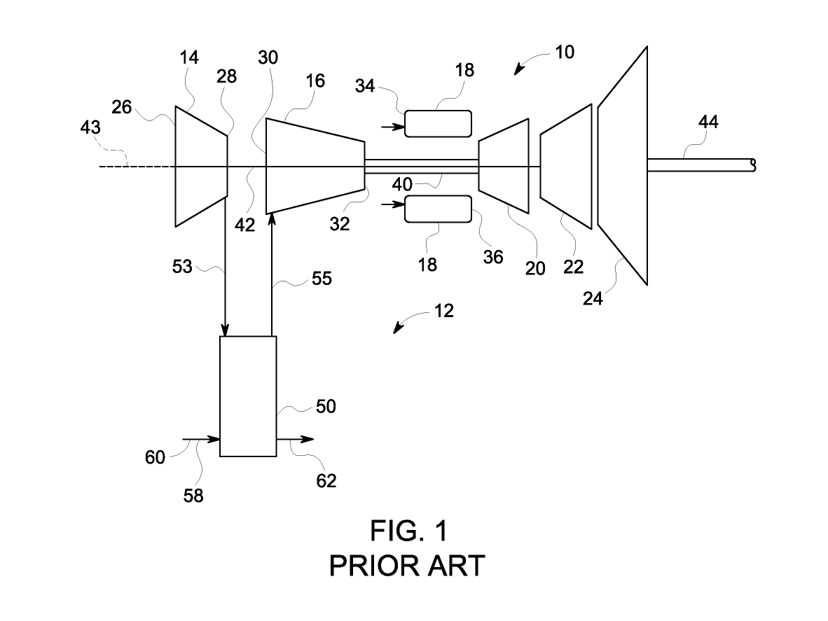

FIG. 1 is a block diagram of a gas turbine engine 10 including an intercooler system 12. Gas turbine engine 10 includes, in serial flow relationship, a low pressure compressor or booster 14, a high pressure compressor 16, a can-annular combustor 18, a high-pressure turbine 20, an intermediate turbine 22, and a power turbine or free turbine 24. Low-pressure compressor or booster 14 has an inlet 26 and an outlet 28, and high-pressure compressor 16 includes an inlet 30 and an outlet 32. Each combustor can 18 has an inlet 34 that is substantially coincident with high-pressure compressor outlet 32, and an outlet 36. In another embodiment, combustor 18 is an annular combustor. In another embodiment, combustor 18 is a dry low emissions (DLE) combustor.

High-pressure turbine 20 is coupled to high-pressure compressor 16 with a first rotor shaft 40, and intermediate turbine 22 is coupled to low pressure compressor 14 with a second rotor shaft 42. Rotor shafts 40 and 42 are each substantially coaxially aligned with respect to a longitudinal centerline axis 43 of engine 10. Engine 10 may be used to drive a load (not shown) which may be coupled to a power turbine shaft 44. Alternatively, the load may be coupled to a forward extension (not shown) of rotor shaft 42.

In operation, ambient air, drawn into low-pressure compressor inlet 26, is compressed and channeled downstream to high-pressure compressor 16. High-pressure compressor 16 further compresses the air and delivers high-pressure air to combustor 18 where it is mixed with fuel, and the mixture is ignited to generate high temperature combustion gases. The combustion gases are channeled from combustor 18 to drive one or more turbines 20, 22, and 24.

The power output of engine 10 is at least partially related to operating temperatures of the gas flow at various locations along the gas flow path. More specifically, in the exemplary embodiment, an operating temperature of the gas flow at high-pressure compressor outlet 32 is closely monitored during the operation of engine 10. Reducing an operating temperature of the gas flow entering high-pressure compressor 16 facilitates decreasing the power input required by high-pressure compressor 16.

To facilitate reducing the operating temperature of a gas flow entering high-pressure compressor 16, intercooler system 12 includes an intercooler 50 that is coupled in flow communication to low pressure compressor 14. Airflow 53 from low-pressure compressor 14 is channeled to intercooler 50 for cooling prior to the cooled air 55 being returned to high-pressure compressor 16.

During operation, intercooler 50 has a cooling fluid 58 flowing therethrough for removing energy extracted from the gas flow path. In one embodiment, cooling fluid 58 is air, and intercooler 50 is an air-to-air heat exchanger. In another embodiment, cooling fluid 58 is water, and intercooler 50 is an air-to-water heat exchanger. Intercooler 50 extracts heat energy from compressed air flow path 53 and channels cooled compressed air 55 to high-pressure compressor 16. More specifically, in the exemplary embodiment, intercooler 50 includes a plurality of tubes (not shown) through which cooling fluid 58 circulates. Heat is transferred from compressed air 53 through a plurality of tube walls (not shown) to cooling fluid 58 supplied to intercooler 50 through inlet 60. Accordingly, intercooler 50 facilitates rejecting heat between low-pressure compressor 14 and high-pressure compressor 16. Reducing a temperature of air entering high-pressure compressor 16 facilitates reducing the energy expended by high-pressure compressor 16 to compress the air to the desired operating pressures, and thereby facilitates allowing a designer to increase the pressure ratio of the gas turbine engine which results in an increase in energy extracted from gas turbine engine 10 and a high net operating efficiency of gas turbine 10.

In an exemplary embodiment, feedwater is flowing through intercooler 50 for removing energy extracted from gas flow path 53 and functions as the cooling fluid 58. The feedwater is being heated or turned into low-pressure (LP) steam, or a combination thereof as described in further detail herein. In this fashion, the extracted heat, if extracted at a higher temperature, ideally approaching that of the hot compressed inlet air, can be a useful contributor to a bottoming cycle generating electricity.

Whether feedwater heating only or steam generation is preferable depends on the bottoming cycle configuration, required feedwater mass flows and intercooler temperatures. Exergy considerations suggest that intermediate or high-pressure feedwater heating can yield the highest available work from the intercooler heat; however, the amount of feedwater to be heated may be more than the bottoming cycle requires and may compete with HRSG economizers. Low-pressure preheating and steam generation is the alternative. The exergy portion can be more than twenty (20) % of the available intercooler heat under typical conditions.

Intercooler 50 may comprise a high efficiency counterflow or cross-counterflow heat exchanger to gain useful heat from intercooling air with feedwater applications. One suitable configuration may include, for example, a serpentine coil fin-tube heat exchanger enclosed within a pressure shell.

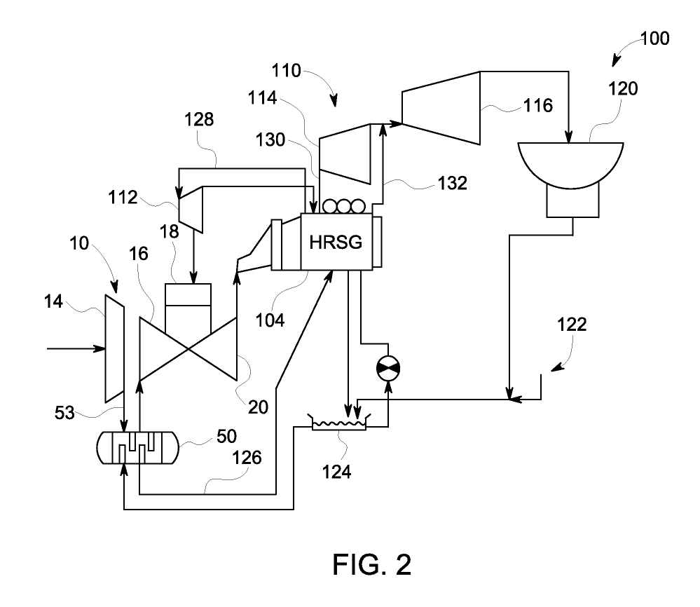

According to one aspect, intercooler 50 may be used to generate hot feedwater or saturated steam by utilizing a significant fraction of the available heat from the hot air in a suitable heat exchanger. This hot feedwater or saturated steam, at low-pressure to facilitate evaporation at temperatures as low as about 100° C., is fed into an evaporator (if hot feedwater) or a superheater (if saturated steam) in a heat recovery steam generator (HRSG) described in further detail herein with reference to FIG. 2, and admitted to a low-pressure turbine, also described in further detail herein. The extra steam then generates additional electricity.

FIG. 2 illustrates a combined cycle power plant 100 according to one embodiment. The power plant 100 comprises a high pressure gas turbine system 10 with a combustion system 18 and a turbine 20. The gas exiting turbine 20 may be at a pressure, for example, of about 45 psi for one particular application. The power plant 100 further comprises a steam turbine system 110. The steam turbine system 110 comprises a high pressure section 112, an intermediate pressure section 114, and one or more low pressure sections 116. The low pressure section 116 exhausts into a condenser 120.

The steam turbine system 100 is associated with a heat recovery steam generator (HRSG) 104. According to one embodiment, the HRSG 104 is a counter flow heat exchanger such that as feedwater passes there through, the water is heated as the exhaust gas from turbine 16 gives up heat and becomes cooler. The HRSG 104 has three (3) different operating pressures (high, intermediate, and low) with means for generating steam at the various pressures and temperatures as vapor feed to the corresponding stages of the steam turbine system 110. The present invention is not so limited however; and it can be appreciated that other embodiments, such as those embodiments comprising a two-pressure HRSG will also work using the principles described herein. Each section of the HRSG 104 generally comprises one or more economizers, evaporators, and superheaters.

The HRSG 104 uses the heat of the turbine 20 exhaust gas to produce three (3) steam streams, a high pressure steam stream 128, an intermediate pressure stream 130, and a low pressure steam stream 132. These three steam streams enter the high, intermediate and low pressure steam turbines 112, 114, 116 to produce power. A high pressure steam stream extracted from the high pressure steam turbine 112 is injected to the gas turbine combustor 18.

Subsequent to exiting the low pressure steam turbine 116, the steam stream enters the condenser 120 where the steam is condensed into liquid water. The liquid water exiting the condenser 120 along with make-up water 122 and residual water from the HRSG 104 enters a water collector 124.

An appropriate amount of water is pumped from the water collector 124 to the HRSG 104 where the water absorbs the heat from the high pressure gas turbine exhaust to generate the requisite steam streams. The three steam streams enter the steam turbines 112, 114, 116 to complete the bottoming cycle.

According to one embodiment, combined cycle power plant 100 further comprises a gas turbine intercooler 50 that operates as described herein before with reference to FIG. 1. Intercooler 50 may comprise, for example, a high efficiency counterflow or cross-counterflow heat exchanger as stated herein, to generate hot feedwater or saturated steam 126 by utilizing a significant fraction of the available heat from the hot air stream 53. This hot feedwater or saturated steam 126, at low pressure to facilitate evaporation at temperatures as low as about 100° C., is fed into an evaporator (if hot feedwater) or a superheater (if saturated steam) in the HRSG 104, and subsequently admitted to the low-pressure turbine 116. The extra steam then generates additional electricity, as stated herein. In this way, system efficiency is advantageously increased while simultaneously decreasing the size of the cooling system.

In summary explanation, a system and method have been described herein for harvesting a significant amount of intercooler heat and generating additional electricity therefrom in a gas turbine bottoming cycle, thus substantially eliminating wasted heat. Since the heat is integrated into the bottoming cycle in the form of steam hot feedwater, no major additional investment is required. The present inventors recognized the foregoing advantages even though intercooler heat has been rarely employed due to the corresponding low temperature(s) and regardless of the low numbers of large gas turbines that employ intercoolers.

While the invention has been described in terms of various specific embodiments, those skilled in the art will recognize that the invention can be practiced with modification within the spirit and scope of the claims.

What is claimed is:

1. A combined gas and steam turbine power plant comprising:
a gas turbine;
a gas turbine intercooler;
a steam turbine; and
a heat recovery steam generator (HRSG) configured to generate steam for driving the steam turbine in response to heated fluid received from the gas turbine intercooler.

2. The combined gas and steam turbine power plant according to claim 1, wherein the heated fluid comprises water.

3. The combined gas and steam turbine power plant according to claim 1, wherein the heated fluid comprises steam.

4. The combined gas and steam turbine power plant according to claim 1, wherein the gas turbine intercooler comprises a counterflow or cross-counterflow heat exchanger.

5. The combined gas and steam turbine power plant according to claim 1, wherein the gas turbine intercooler comprises a serpentine coil fin-tube heat exchanger enclosed within a pressure shell.

6. A combined gas and steam turbine power plant comprising:
a gas turbine;
a gas turbine intercooler;
a steam turbine; and
a heat recovery steam generator (HRSG) connected downstream from a low-pressure gas turbine compressor and upstream from a high-pressure gas turbine compressor in a steam cycle, wherein the HRSG is configured to generate steam for driving the steam turbine in response to a heat transfer medium received via the gas turbine intercooler.

7. The combined gas and steam turbine power plant according to claim 6, wherein the heat transfer medium comprises water.

8. The combined gas and steam turbine power plant according to claim 6, wherein the heat transfer medium comprises steam.

9. The combined gas and steam turbine power plant according to claim 6, wherein the gas turbine intercooler comprises a counterflow or cross-counterflow heat exchanger.

10. The combined gas and steam turbine power plant according to claim 6, wherein the gas turbine intercooler comprises a serpentine coil fin-tube heat exchanger enclosed within a pressure shell.

11. A combined gas and steam turbine power plant comprising:
a gas turbine;
a gas turbine intercooler;
a steam turbine; and
a heat recovery steam generator (HRSG), wherein the gas turbine intercooler is configured to recover heat and use substantially all of the recovered heat to produce hot water and steam for driving the steam turbine.

12. The combined gas and steam turbine power plant according to claim 11, wherein the heat transfer medium is water.

13. The combined gas and steam turbine power plant according to claim 11, wherein the heat transfer medium is steam.

14. The combined gas and steam turbine power plant according to claim 11, wherein the gas turbine intercooler comprises a counterflow or cross-counterflow heat exchanger.

15. The combined gas and steam turbine power plant according to claim 11, wherein the gas turbine intercooler comprises a serpentine coil fin-tube heat exchanger enclosed within a pressure shell.
